(19) United States
(12) Patent Application Publication
(10) Pub. No.: US 2015/0305568 A1
(43) Pub. Date: Oct. 29, 2015

(54) DISPOSABLE CONTAINER FOR POWDER MATERIAL WITH AN INTEGRATED SIFTER

(71) Applicants: Dekel EDRI, Ramle (IL); Avi SARANO, Ramle (IL)

(72) Inventors: Dekel EDRI, Ramle (IL); Avi SARANO, Ramle (IL)

(73) Assignees: Dekel EDRI, Ramle (IL); Avi SARANO, Ramle (IL); Shimeon MICHAELI, Nes Tziona (IL); Mirit HARARI, Batzra (IL)

(21) Appl. No.: 14/261,381

(22) Filed: Apr. 24, 2014

(51) Int. Cl. A47J 43/22; B07B 1/02

(52) U.S. Cl. CPC A47J 43/22; B07B 1/02

(57) ABSTRACT

A disposable container-assembly for shipping, storing and dispensing powder material such as flour, having a container body, in which the powder material is stored, and a sifter-assembly. The sifter-assembly includes a sifter-assembly-body having an enclosed wall that forms a top-end opening and a bottom-end opening. The sifter-assembly-body includes a blocking cover, a powder-clumps-breaking device and a sieve, wherein the powder-clumps-breaking device is secured between the top-end opening of the sifter-assembly-body and the sieve. The bottom portion of the container body sealingly encloses the top-end opening of the sifter-assembly-body. The blocking cover prevents an escape of powder material from the container body, during the storing or shipping states of the disposable container-assembly. The blocking cover is removed to facilitate sifting and dispensing of powder material from the container body.

### CROSS REFERENCE TO RELATED APPLICATION

This application is a continuation in part of PCT application PCT/IL2012/000359, filed Oct. 17, 2012, the disclosure of which is incorporated by reference for all purposes as if fully set forth herein.

### FIELD OF THE INVENTION

The present invention relates to the field of containers for storing powder material and more particularly, the present invention is related to disposable storage systems or containers for storing and dispensing powder material such as flour or any other particulate matter, the container including an integrated sifter.

### BACKGROUND OF THE INVENTION

Generally, in a container including a sifter, the sifter of is typically used to control the dispensing rate of the powder material stored in the container, wherein that powder material has been sorted out beforehand.

However, the sifter may also be used as a sieve to sort out unwanted particles, typically larger in size than the powder material, such as flour.

Hence, there is a need for and it would be advantageous to have a container including an integrated sifter for storing and dispensing the powder material, while sorting out unwanted particles.

It should be noted that the present invention will describe, with no limitations, the powder material stored in the container as being flour. But the present invention is not limited to containers for storing flour and any other powder or particulate matter may be stored in the container.

### SUMMARY OF THE INVENTION

The principle intentions of the present invention include providing a container for storing and dispensing powder material such as flour or any other particulate matter, the container including an integrated sifter. Typically, the particulate matter is stored and shipped in the container of the present invention, wherein the particulate matter is dispensed through the sieve, to thereby prevent from unwanted particles, larger than the sieve's fine holes from being dispensed. Typically, the container with the integrated sifter is disposable.

According to teachings of the present inventions there is provided a disposable container-assembly for shipping, storing and dispensing powder material such as flour. The disposable container-assembly includes a container body, wherein the powder material is stored in the container body, and a sifter-assembly.

The sifter-assembly includes a sifter-assembly-body having an enclosed wall that forms a top-end opening and a bottom-end opening. The enclosed wall may form any preconfigured shape. The sifter-assembly-body includes a blocking cover, a powder-clumps-breaking device, and a sieve, wherein the powder-clumps-breaking device is secured between the top-end opening of the sifter-assembly-body and the sieve.

The bottom portion of the container body sealingly encloses the top-end opening of the sifter-assembly-body.

The blocking cover prevents an escape of powder material from the container body, during the storing or shipping states of the disposable container-assembly. The blocking cover is removed to facilitate sifting and dispensing of powder material from the container body.

Preferably, the sifter-assembly further includes a locking mechanism for locking the blocking cover onto the sifter-assembly-body, and thereby sealingly enclosing the bottom-end opening of the sifter-assembly-body.

The openings in the powder-clumps-breaking device facilitate, during a sifting process, the break apart of large powder clumps. The sifter-assembly further includes a bulk of parts, dimensioned to stay in between the powder-clumps-breaking device and the sieve, wherein the parts further break apart the remaining powder-clumps into yet smaller parts.

In some embodiments, the powder-clumps-breaking device is a powder-clumps-breaking-grid (160).

In some embodiments, the powder-clumps-breaking device includes a first powder-clumps-breaking unit and a second powder-clumps-breaking unit. The first powder-clumps-breaking unit includes a hollowed body, enclosed at one end by a first partition (264), while the other end is an open end, wherein one or more first elongated openings (266) are formed in the first partition. The second powder-clumps-breaking unit includes a hollowed body, enclosed at one end by a second partition (234), while the other end is an open end, wherein one or more second elongated openings (236) are formed in the first partition. When assembled, the second elongated openings are generally traversal to the first elongated openings.

Preferably, the one or more second elongated openings are partially occluded by inclined walls (238), wherein the inclined walls are inclined towards the first powder-clumps-breaking unit.

Optionally, supporting ribs (239) are added to support the three open edges of each of the inclined walls to the second partition.

An aspect of the present invention is to provide a method for storing, sifting and dispensing powder material. The method includes the steps of providing the disposable container-assembly of the present invention; removing the blocking cover to facilitate sifting and dispensing of the powder material stored in the container body; and shaking the sifter-assembly sideways causing motion of powder material from the container body to pass through the openings in the powder-clumps-breaking device, thereby breaking apart of large powder clumps, and motion of fine powder material to pass through the fine hole of the sieve, thereby out of the disposable container-assembly.

Optionally, the sifter-assembly further includes a bulk of parts, dimensioned to stay in between the powder-clumps-breaking device and the sieve, wherein the parts further break apart the remaining powder-clumps into yet smaller parts, during the shaking of the sifter-assembly, sideways.

### BRIEF DESCRIPTION OF THE DRAWINGS

The present invention will become fully understood from the detailed description given herein below and the accompanying drawings, which drawings are generally not drawn to scale and are given by way of illustration only and thus, not limitative of the present invention, and wherein:

FIG. 1 is an isometric view of a disposable container-assembly, according to some embodiments of the present invention, the container including an integrated sifter-assembly.

FIG. 2 is a top isometric view illustration of the sifter-assembly of the disposable container-assembly shown in FIG. 1.

FIG. 3 is a sectioned side view illustration of the sifter-assembly of the disposable container-assembly shown in FIG. 2.

FIG. 4 is a sectioned side view illustration of the sifter-assembly of the disposable container-assembly shown in FIG. 3, after the blocking cover has been removed.

FIG. 5 is a sectioned isometric view illustration of the disposable container-assembly shown in FIG. 1.

FIG. 6 is a top isometric exploded view illustration of the sifter-assembly of the disposable container-assembly shown in FIG. 2.

FIG. 7 is a top isometric view of examples of powder-clumps-breaking-grids, according to variations of the present invention.

FIG. 8 is a top isometric view illustration of the body of the sifter-assembly of the disposable container-assembly shown in FIG. 1.

FIG. 9 is an isometric view of the disposable container-assembly r shown in FIG. 1, the disposable container-assembly being in use.

FIG. 10 is an isometric view of a container-assembly for powder material, according to some embodiments of the present invention, the container-assembly including an integrated sifter-assembly.

FIG. 11 is a top isometric exploded view illustration of the container-assembly shown in FIG. 10.

FIG. 12 is a top isometric view of an example of a first powder-clumps-breaking unit, according to variations of the present invention.

FIG. 13 is a top isometric view of an example of a second powder-clumps-breaking unit, according to variations of the present invention.

FIG. 14a is a side view of the second powder-clumps-breaking unit shown in FIG. 13.

FIG. 14b is a sectioned side view of the second powder-clumps-breaking unit shown in FIG. 13.

FIG. 15 is a bottom isometric view illustration of second powder-clumps-breaking unit shown in FIG. 13.

FIG. 16 is a sectioned side view illustration of the container-assembly shown in FIG. 10.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

It should be noted that orientation related descriptions such as “bottom”, “up”, “upper”, “down”, “lower”, “top” and the like, assumes that the associated item is operationally situated.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

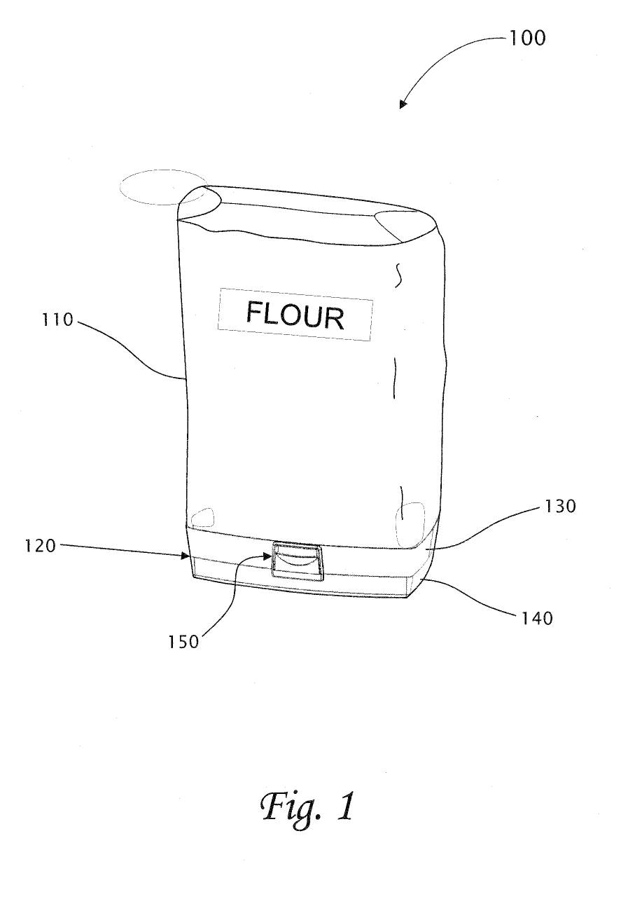

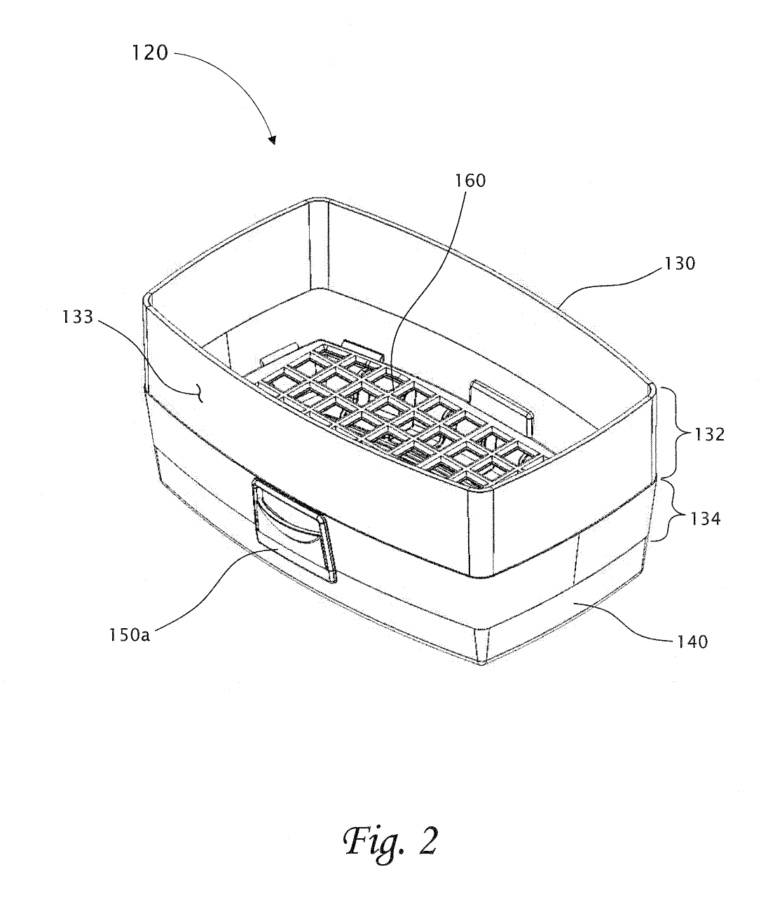

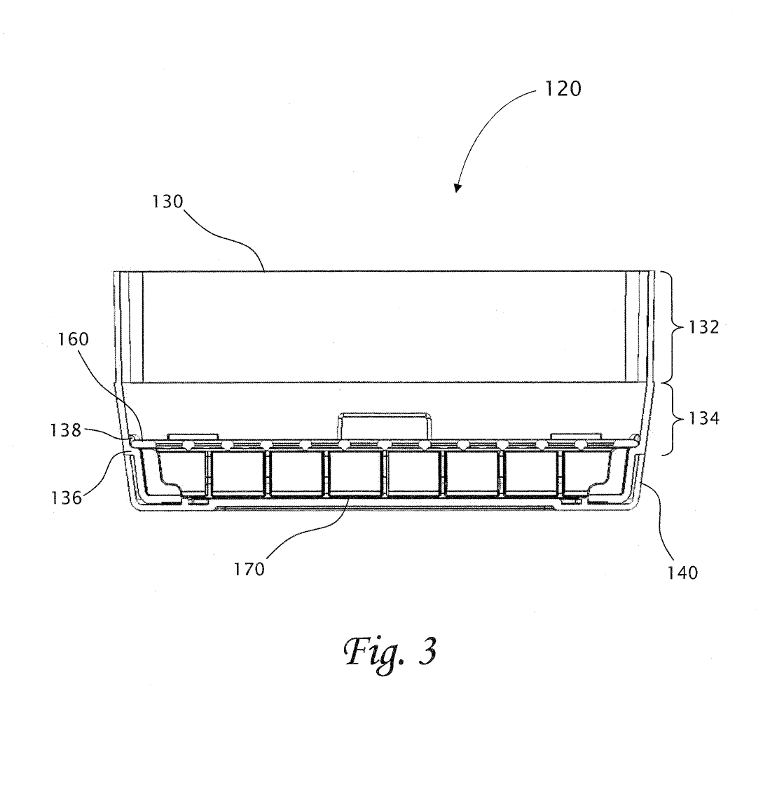

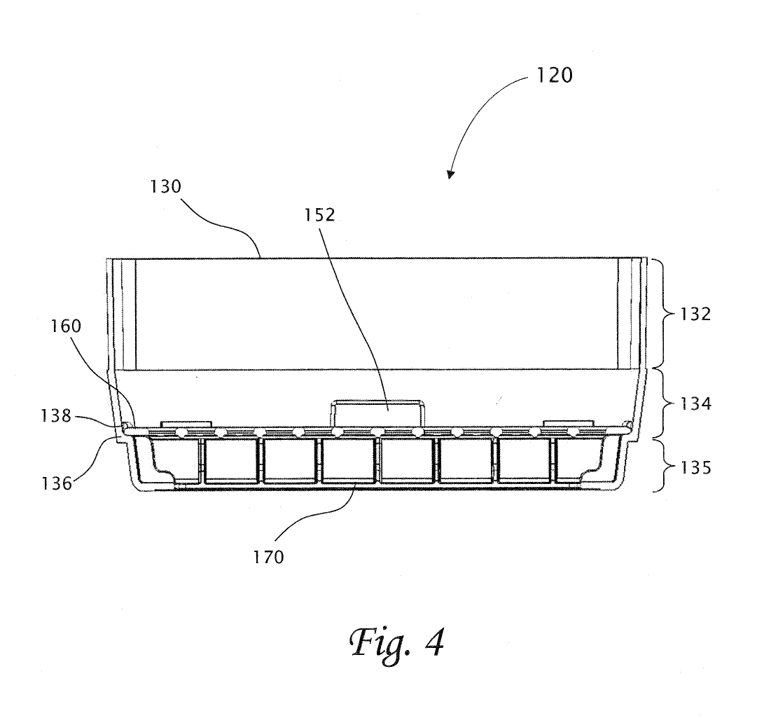

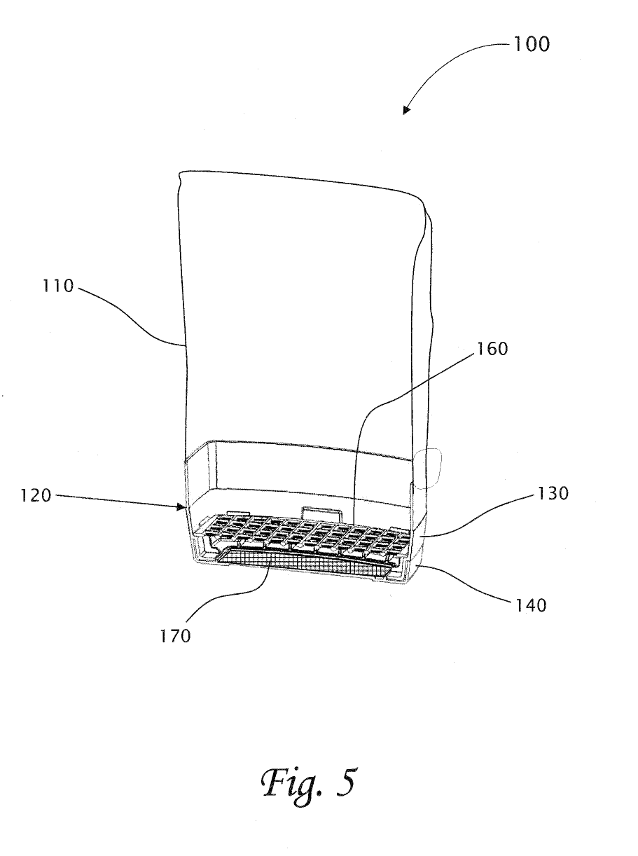

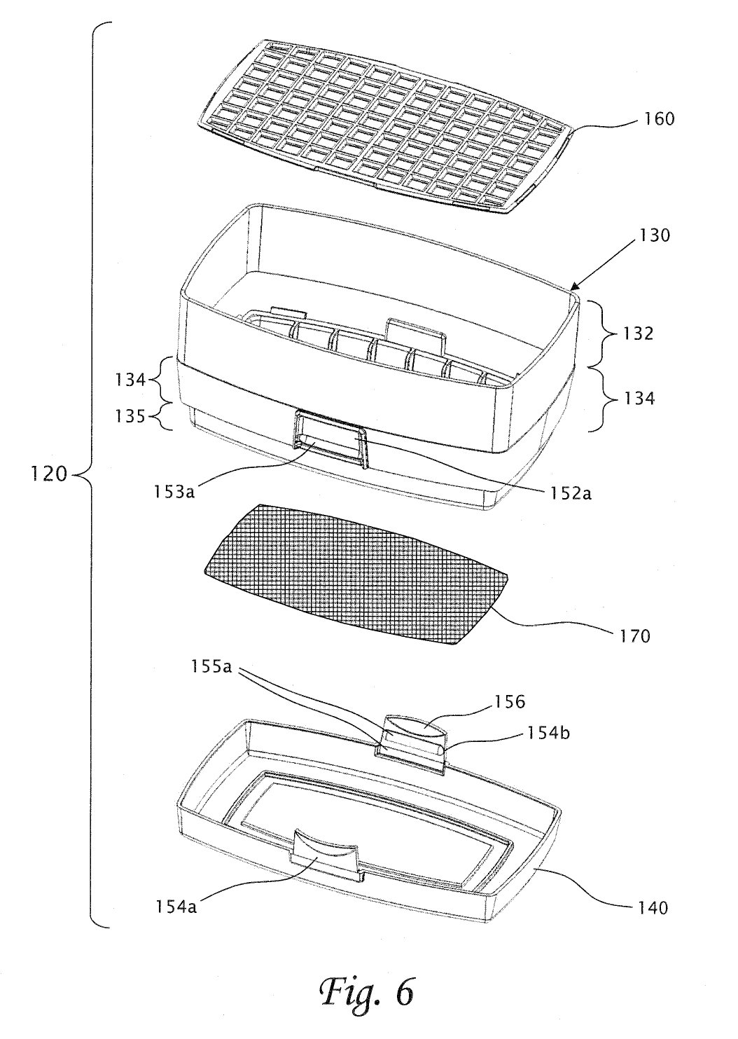

Reference is made to the drawings. FIG. 1 is an isometric view of a disposable container-assembly 100, according to embodiments of the present invention. Disposable container-assembly 100 includes container body 110 and an integrated sifter-assembly 120. Reference is also made to FIG. 2, a top isometric view illustration of sifter-assembly 120; to FIG. 3, a sectioned side view illustration of sifter-assembly 120; to FIG. 4, a sectioned side view illustration of sifter-assembly 120, after the blocking cover has been removed; to FIG. 5, a sectioned isometric view illustration of disposable container-assembly 100; and to FIG. 6, illustrating a top isometric exploded view of sifter-assembly 120.

Sifter-assembly 120 includes a sifter-assembly-body 130, a blocking cover 140, a powder-clumps-breaking-grid 160 and a sieve 170. Sifter-assembly 120 also includes a locking mechanism 150 for interlocking blocking cover 140 onto sifter-assembly-body 130.

Locking mechanism 150 shown in the drawings is given by way of example only, and other interlocking embodiments know in the art may be used within the scope of the present invention. Locking mechanism 150 includes a first pair of locking-elements 154 integrated into blocking cover 140, and a second pair of locking-elements 152 integrated into sifter-assembly-body 130. In the example locking mechanism 150 shown in the figures, each locking-element 152 includes a male-member 153, and each locking-element 154 includes a respective female-member 155. When a male-member 153 is pressed against a respective female-member 155 to cling-on thereto, locking mechanism 150 fittingly enters into a locking state and thereby, powder material stored in disposable container-assembly 100 cannot escape container body 110. In FIGS. 1 and 2, locking mechanism 150 is shown in locking state.

Container body 110 is made of material suitable to store the designate powder material. It may be made of materials such as paper, nylon, plastic and other polymers, PET (Polyethylene Terephthalate) or any other material commonly used to store the corresponding powder material.

Sifter-assembly-body 130 is a hollowed body, having enclosing walls forming two open ends. A first open-end, typically the top end, that remains open such that the inner space of sifter-assembly-body 130 coincides with the inner space of container body 110. It should be noted that “top” and “bottom”, as used herein, refers to the common operational orientation of disposable container-assembly 100, when the sifter is being used. The second open-end, typically the bottom end, is detachably enclosed by blocking cover 140.

Sifter-assembly-body 130 has a top section 132, proximal to the first open-end, a middle section 134 is proximal to the second open-end and a bottom section 135. The bottom end of container body 110 an open end, wherein the bottom portion of container body 110 is sealingly attached to top section 132 of sifter-assembly-body 130, for example by glue, by heat, or the two are made of the same material, being integrated into a single part. Typically, with no limitation, the bottom portion of container body 110 is sealingly attached to the external surface 133 of top section 132, as shown in FIG. 1. In variations of the present invention, the bottom portion of container body 110 is sealingly attached to the internal surface of top section 132. Bottom section 135 is indented inwardly with respect to middle section 134.

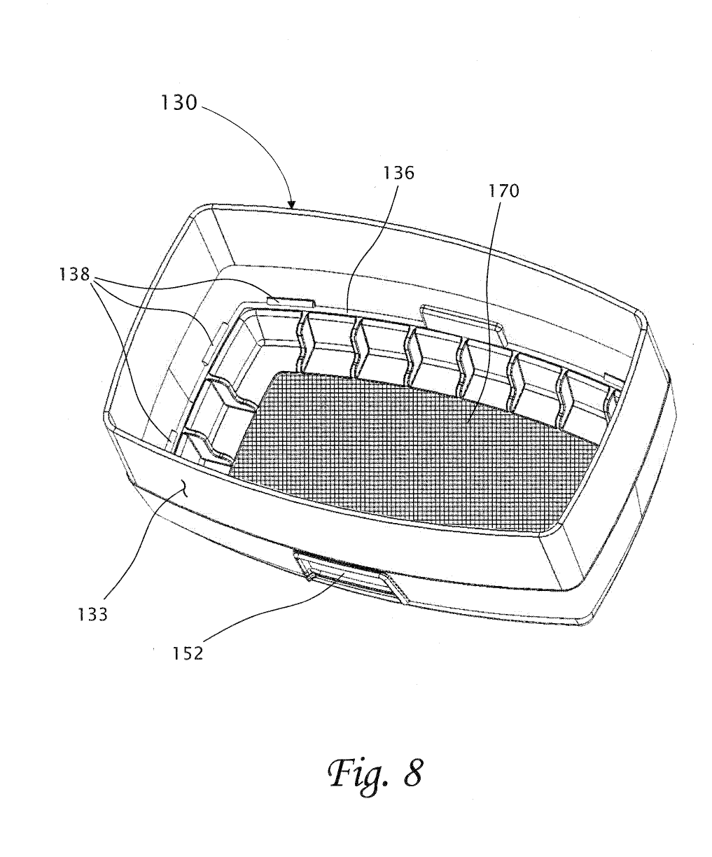

Reference is also made to FIG. 8, illustrating a top isometric view of sifter-assembly-body 130 of sifter-assembly 120 of disposable container-assembly 100. On two or more of the internal walls of sifter-assembly-body 130, a supporting bench 136 is formed, inwardly, as a result of the inwardly indentation of bottom section 135 with respect to middle section 134. Powder-clumps-breaking-grid 160 is fittingly dimensioned to be disposed on top of supporting bench 136. Preferably, when assembled, powder-clumps-breaking-grid 160 is pushed downwards, to surpass stoppers 138, which stoppers 138 keep powder-clumps-breaking-grid 160 in proximity to supporting bench 136, even when disposable container-assembly 100 is not situated in a general vertical orientation.

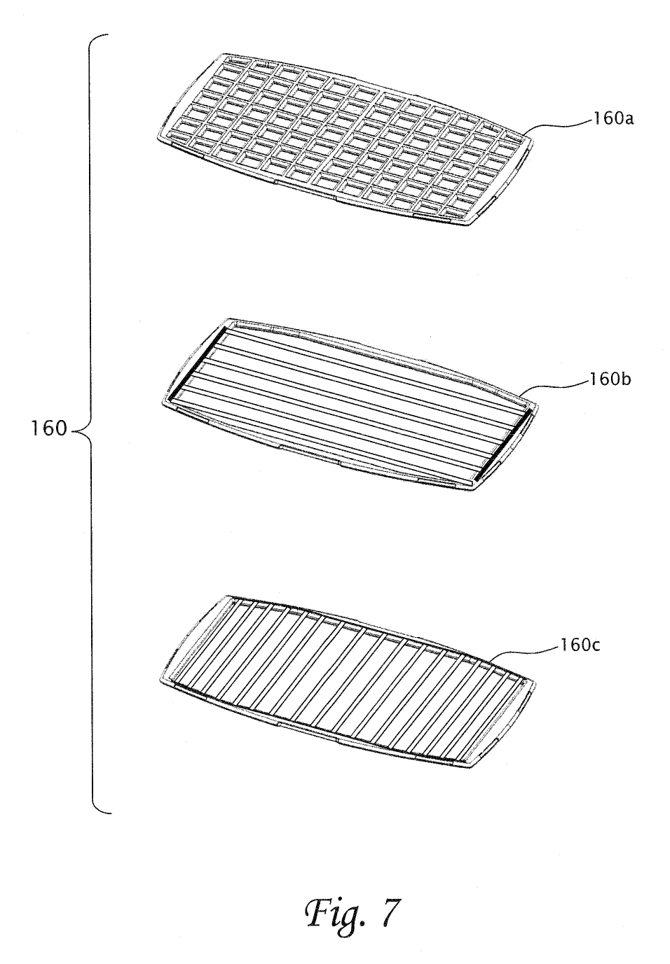

It should be noted that powder-clumps-breaking-grid 160 may be formed in different geometrical layouts. FIG. 7 is a top isometric view of some examples of powder-clumps-breaking-grids 160 (160a, 160b and 160c), according to variations of the present invention.

Sieve 170 is shaped to overcast the second (bottom) open-end of sifter-assembly-body 130 and is typically securely attached, for example, with no limitation, by glue or heat, to the external surface of the bottom side of bottom section 135 of sifter-assembly-body 130 (see FIG. 8, as well as FIG. 4).

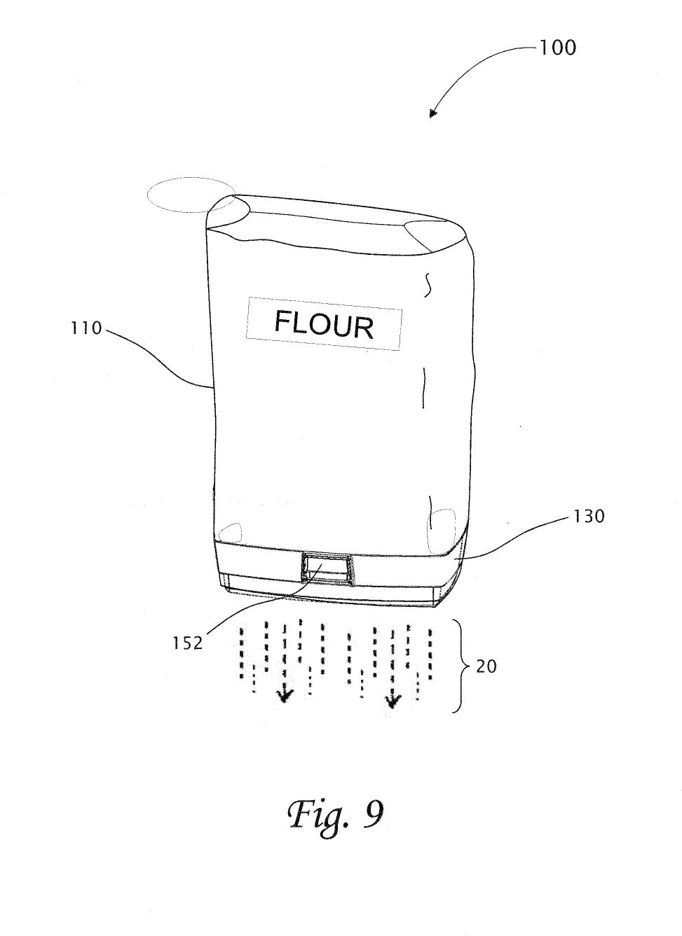

Reference is also made to FIG. 9, an isometric view of disposable container-assembly 100, which disposable container-assembly is shown being in use. Locking mechanism 150 is in an unlocked-state, as blocking cover 140 has been removed.

Particles 20 of the particulate matter that were stored inside disposable container-assembly 100, are shown being dispensed out of the second (bottom) open-end of sifter-assembly-body 130. Typically, a slight shaking of disposable container-assembly 100 is required to dispense particles 20 out of disposable container-assembly 100.

It should be noted that some types of particulate matter that were stored inside disposable container-assembly 100, such as flour, tend to cluster together to form a clumps of the powdery matter. When such large clumps of powdery matter reach, as is, the upper surface of sieve 170, which is typically made from a fine grid, the sifting process tend to be slow and inefficient. Therefore, by placing powder clumps-breaking-grid 160 before sieve 170, any formed large powder clumps are broken apart by powder-clumps-breaking-grid 160 into smaller parts, making the powdery matter substantially fluffier.

It should be further noted that adding a bulk of parts (not shown), such as small globules, dimensioned to stay in between powder-clumps-breaking-grid 160 before sieve 170, further breaks the remaining powder-clumps into yet smaller parts making the powdery matter even more fluffy.

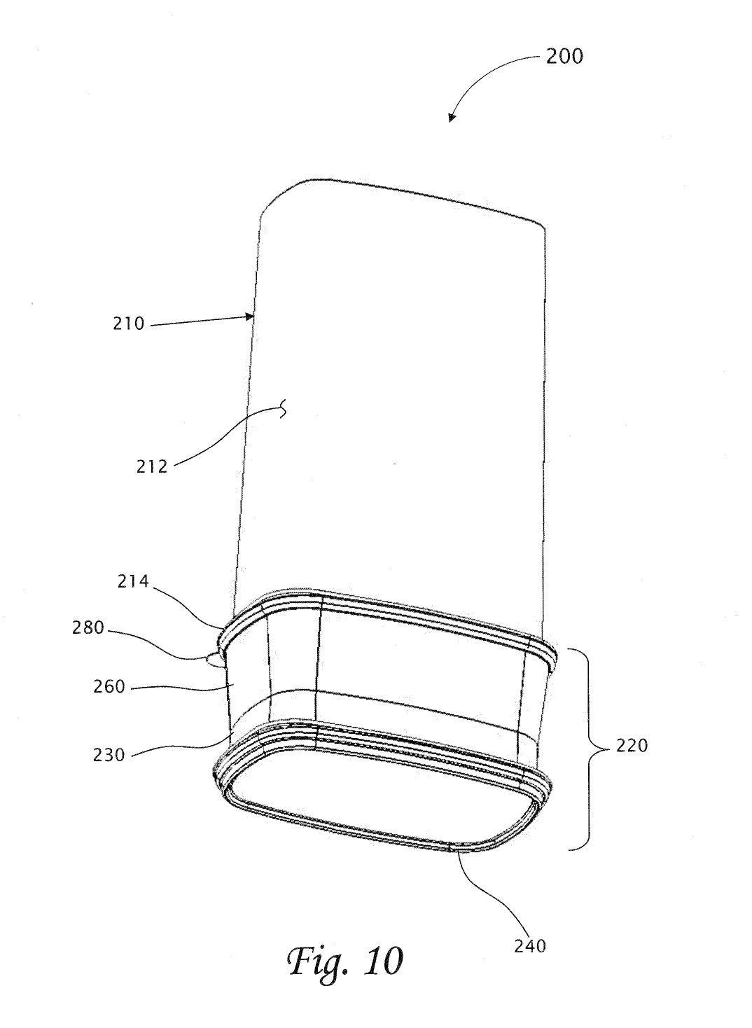

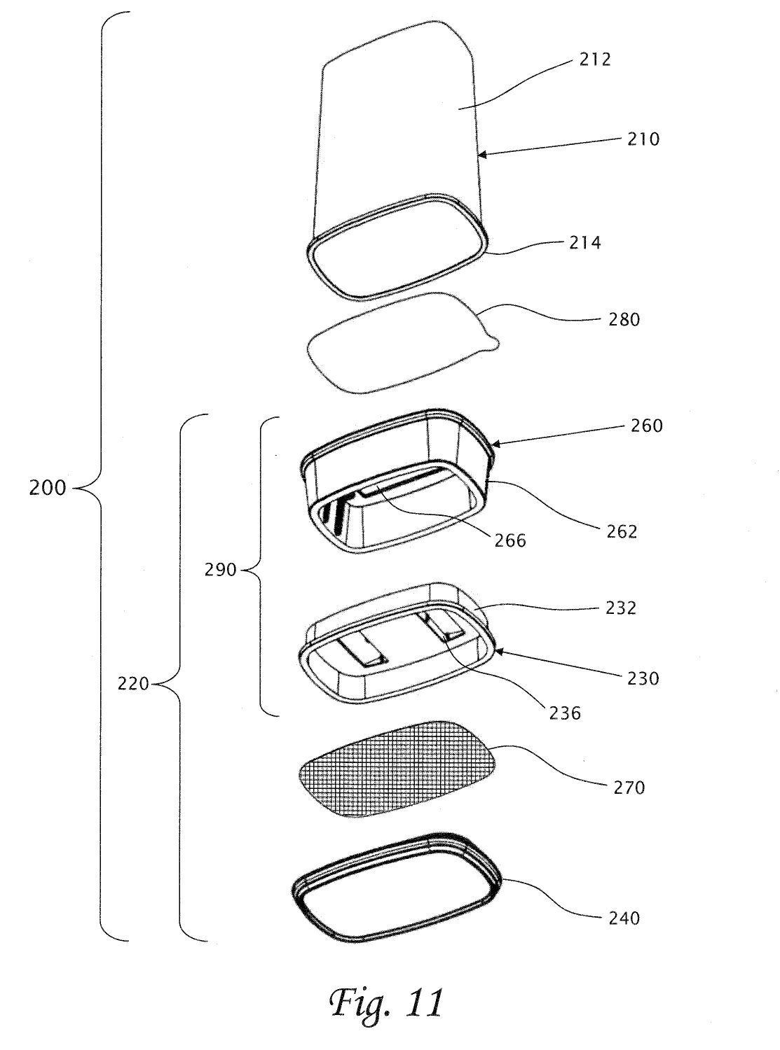

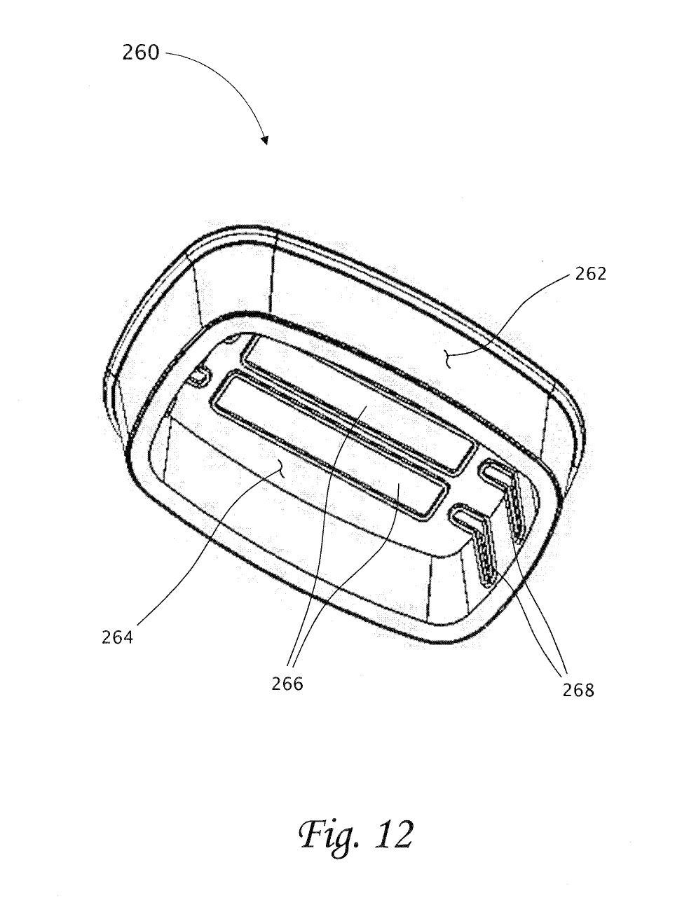

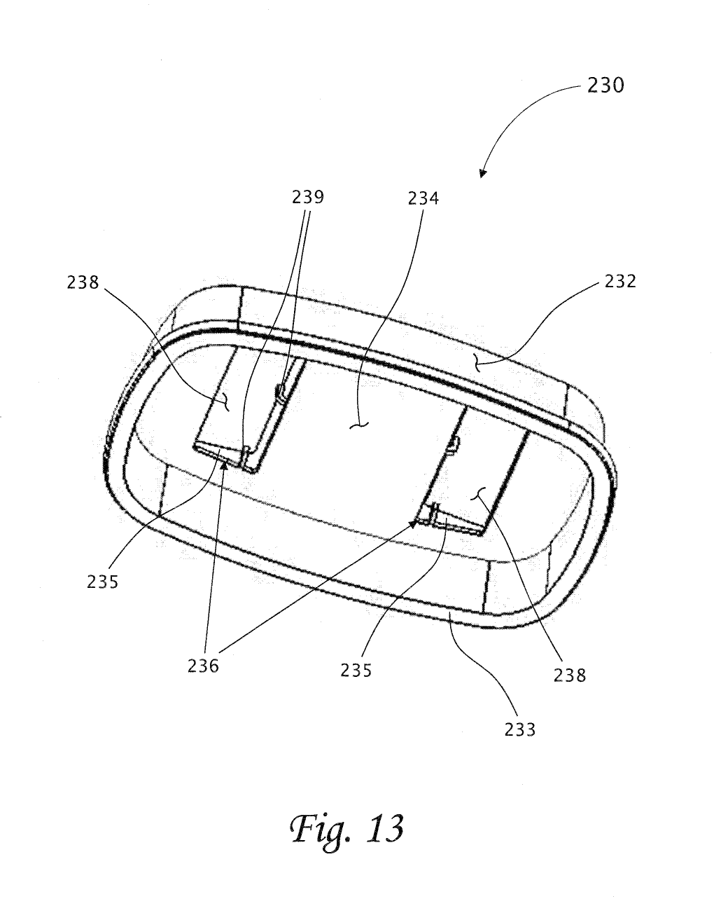

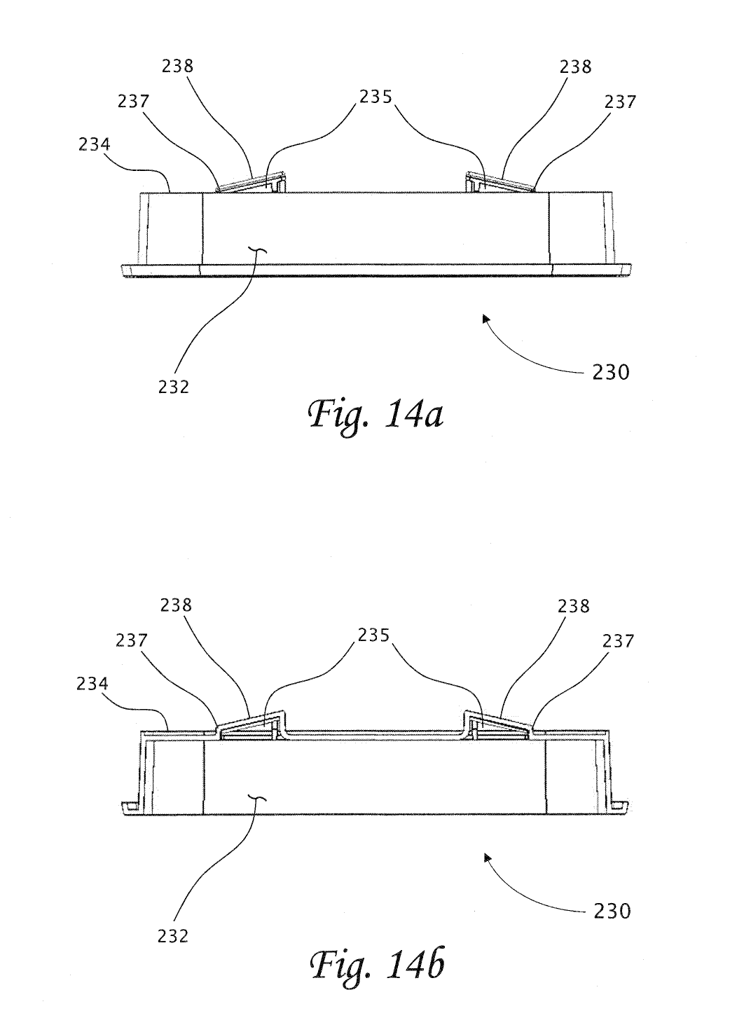

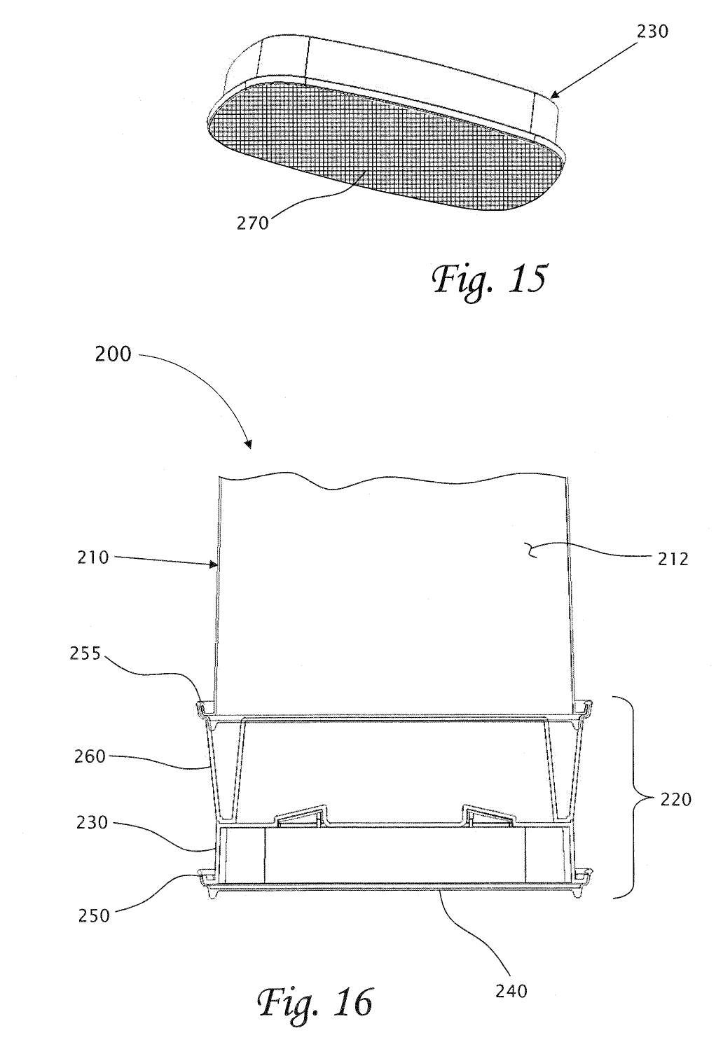

Reference is now made to FIG. 10, illustrating an isometric view of a container-assembly 200, according to embodiments of the present invention. Container-assembly 200 includes a container body 210 and an integrated sifter-assembly 220. Reference is also made to FIG. 11, illustrating a top isometric exploded view illustration of the container-assembly 200; to FIG. 12, illustrating a top isometric view of an example of a first powder-clumps-breaking unit 260, according to variations of the present invention; to FIG. 13, illustrating a top isometric view of an example of a second powder-clumps-breaking unit 230, according to variations of the present invention; to FIG. 14a, a side view of second powder-clumps-breaking unit 230; to FIG. 14b, illustrating a sectioned side view of second powder-clumps-breaking unit 230; and to FIG. 15, illustrating a sectioned side view illustration of container-assembly 200.

Sifter-assembly 220 includes a powder-clumps-breaking assembly 290 having a second powder-clumps-breaking unit 230 and first powder-clumps-breaking unit 260. Sifter-assembly 220 also includes a sieve 270, a blocking cover 240 and a locking mechanism 250 for interlocking blocking cover 240 onto sifter-assembly-body 230, and a locking mechanism 255 for interlocking powder-clumps-breaking unit 260 onto an open-end-rim 214 of container body 210. Sifter-assembly 220 may further include an intruding protection such as foil 280.

Locking mechanisms 250 and 255, shown in drawing 15, are given by way of example only. Any type of prior art locking mechanisms may be used. Furthermore, any type of prior art intruding protection may be used.

Container body 210 is made of material suitable to store the designate powder material. It may be made of materials such as cardboard, nylon, plastic and other polymers, PET (Polyethylene Terephthalate) or any other material commonly used to store the corresponding powder material.

First powder-clumps-breaking unit 260 includes a hollowed body, having enclosing walls 262 that are enclosed at one end by a first partition 264, while the other end is an open end that typically, detachably interlocks with open-end-rim 214 of container body 210. One or more elongated openings 266 are formed in first partition 264.

Second powder-clumps-breaking unit 230 is designed to further break down powder clumps that remain after passing through elongated openings 264. Second powder-clumps-breaking unit 230 includes a hollowed body, having enclosing walls 232 that are enclosed at one end by a second partition 234, while the other end is an open end. Powder-clumps-breaking assembly 290 is assembled such that the inner wall surface of first powder-clumps-breaking unit 260 coincides with the external wall surface of second powder-clumps-breaking unit 230.

One or more elongated openings 236 are formed in second partition 234, wherein when assembled, elongated openings 236 are generally traversal to elongated openings 266. Preferably, at least one elongated opening 236 is partially blocked by an inclined wall 238, extending from a first edge 237 of the least one elongated opening 236 towards and away from the edge of the least one elongated opening 236 opposing first edge 237 of the least one elongated opening 236. A gap 235 is formed between inclined wall 238 and the edges of the least one elongated opening 236 other than first edge 237. Supporting ribs 239 may be added to support the three open edges of inclined wall 238 to second partition 234, wherein inclined walls 238 are inclined towards first powder-clumps-breaking unit 260.

It should be noted that elongated opening 236, elongated opening 266 and inclined walls 238 may be formed in different geometrical layouts, according to variations of the present invention.

Rim 233 at the open-end of second powder-clumps-breaking unit 230, typically the bottom end, is detachably enclosed by blocking cover 240, wherein sieve 270 is shaped to overcast the (bottom) open end of second powder-clumps-breaking unit 230 and is typically securely attached thereto (see FIG. 15), for example, with no limitation, by glue or heat. It should be noted that “top” and “bottom”, as used herein, refers to the common operational orientation of container-assembly 200, when the sifter is being used.

It should be noted that some types of particulate matter that were stored inside container-assembly 200, such as flour, tend to cluster together to form clumps of the powdery matter. When such large clumps of powdery matter reach, as is, the upper surface of sieve 270, which is typically made from a fine grid, the sifting process tend to be slow and inefficient. Therefore, by placing powder clumps-breaking device 260 before sieve 270, any formed large powder clumps are broken apart by powder-clumps-breaking device 260 into smaller parts, making the powdery matter substantially fluffier.

By placing powder-clumps-breaking assembly 290 before sieve 270, any formed large powder clumps are broken apart when forced to pass through elongated openings 264. Clump of powder material coming from container body 210 is broken into smaller parts. The clump of powder material first powder-clumps-breaking unit 260 are then passed through elongated openings 234, such that the clump of powder material are further broken apart into yet smaller parts, before reaching sieve 270.

It should be further noted that adding a bulk of parts (not shown), such as small globules, dimensioned to stay in between powder-clumps-breaking device 260 before sieve 270, further breaks the remaining powder-clumps into yet smaller parts making the powdery matter even more fluffy.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A disposable container-assembly (100,200) for shipping, storing and dispensing powder material, comprising:
a) a container body (110,210) wherein the powder material is stored in said container body; and
b) a sifter-assembly (120,220) comprising:
i. a sifter-assembly-body (130, [230 and 260]) having an enclosed wall, forming a top-end opening and a bottom-end opening;
ii. a blocking cover (140,240);
iii. a powder-clumps-breaking device; and
iv. a sieve (170,270),
wherein the bottom portion of said container body sealingly encloses said top-end opening of said sifter-assembly-body;
wherein said blocking cover prevents an escape of powder material from said container body during a storing or shipping states of the disposable container-assembly, and said blocking cover is removed to facilitate sifting and dispensing of powder material from said container body; and
wherein said powder-clumps-breaking device is secured between said top-end opening of said sifter-assembly-body and said sieve.

2. The disposable container-assembly of claim 1, wherein said sifter-assembly further comprises:
v. a locking mechanism for locking said blocking cover onto said sifter-assembly-body, and thereby sealingly enclosing said bottom-end opening of said sifter-assembly-body.

3. The disposable container-assembly of claim 1, wherein the openings in said powder-clumps-breaking device facilitate, during a sifting process, the break apart of large powder clumps.

4. The disposable container-assembly of claim 3, wherein said sifter-assembly further comprises a bulk of parts, dimensioned to stay in between said powder-clumps-breaking device and said sieve, and wherein said parts further break apart the remaining powder-clumps into yet smaller parts.

5. The disposable container-assembly of claim 1, wherein the powder material is flour.

6. The disposable container-assembly of claim 1, wherein said powder-clumps-breaking device is a powder-clumps-breaking-grid.

7. The disposable container-assembly of claim 1, wherein said powder-clumps-breaking device comprises:
a) a first powder-clumps-breaking unit (260); and
b) a second powder-clumps-breaking unit (230),
wherein said first powder-clumps-breaking unit includes a hollowed body, enclosed at one end by a first partition (264), while the other end is an open end, and wherein one or more first elongated openings (266) are formed in said first partition;
wherein said second powder-clumps-breaking unit includes a hollowed body, enclosed at one end by a second partition (234), while the other end is an open end, and wherein one or more second elongated openings (236) are formed in said first partition; and
wherein when assembled, said second elongated openings are generally traversal to said first elongated openings.

8. The disposable container-assembly of claim 7, wherein said one or more second elongated openings are partially occluded by inclined walls (238), wherein said inclined walls are inclined towards said first powder-clumps-breaking unit.

9. The disposable container-assembly of claim 8, wherein supporting ribs (239) are added to support the three open edges of each of said inclined walls to said second partition.

10. A method for storing, sifting and dispensing powder material, comprising the steps of:
a) providing a disposable container-assembly, including:
i. a container body wherein powder material is stored in said container body; and
ii. a sifter-assembly comprising:
A. a sifter-assembly-body having an enclosed wall, forming a top-end opening and a bottom-end opening;
B. a blocking cover;
C. a powder-clumps-breaking-grid; and
D. a sieve,
wherein said container body is sealingly attached onto said top-end opening of said sifter-assembly-body;
wherein said blocking cover prevents an escape of powder material from said container body during a storing or shipping states of the disposable container-assembly; and
wherein said powder-clumps-breaking device is secured between said top-end opening of said sifter-assembly-body and said sieve;
b) removing said blocking cover to facilitate sifting and dispensing of the powder material stored in said container body; and
c) shaking said sifter-assembly sideways causing:
i) motion of powder material from said container body to pass through the openings in said powder-clumps-breaking device, thereby breaking apart of large powder clumps; and
ii) motion of fine powder material to pass through the fine hole of said sieve, thereby out of said disposable container-assembly.

11. The method of claim 10, wherein said sifter-assembly further comprises a bulk of parts, dimensioned to stay in between said powder-clumps-breaking device and said sieve, and wherein said parts further break apart the remaining powder-clumps into yet smaller parts, during said shaking of said sifter-assembly, sideways.
